(19) United States
(12) Patent Application Publication
(10) Pub. No.: US 2012/0009306 A1
(43) Pub. Date: Jan. 12, 2012

(54) Edible leak proof container, the method and apparatus for production

(76) Inventor: Randy A. Roth, North Vancouver (CA)

(21) Appl. No.: 12/662,604

(22) Filed: Jul. 9, 2010

(51) Int. Cl. A23P 1/10; A21D 6/00; A21D 13/00

(52) U.S. Cl. 426/140; 99/442; 426/138; 426/505

(57) ABSTRACT

An edible container, the means of and apparatus for its production where the container has the shape of a tube with a closed bottom end, an opened top end and an annular wall extending from the bottom end to the top end; said container is handheld, lightly crusted on the inside and outside and comprised of an egg-based dough thus creating a virtually leak proof container. The apparatus is comprised of a pair of Teflon coated complimentary female half-molds, each half-mold having a concave inner surface. Means of production involves initiating a dough heating process using a heating element source and vibrating the complimentary female half-molds at a frequency that enhances product uniformity and allowing heated gases to escape thus minimizing any seam vestige.

This application claims priority to the provisional patent No. 61/214,595 filed on Apr. 27, 2009

### BRIEF DESCRIPTION OF THE DRAWINGS

FIG. 1 is a side perspective view of a the present invention;

FIG. 2 is a top perspective view thereof.

FIG. 3 is a side view of the female mold, left & right halves with assembly

FIG. 4 is a side perspective of the male mold insert

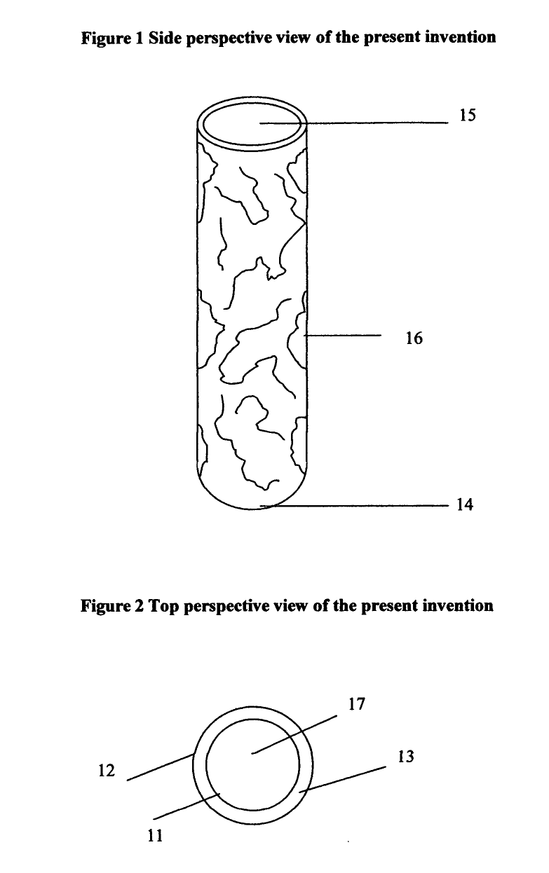

### DETAILED DESCRIPTION OF PREFERRED EMBODIMENTS

The present invention consists of an edible container, the means of and apparatus for its production.

The edible container is comprised of an egg-based dough that is necessarily high in protein-based gluten that it creates a non-permeable, leak-proof yet edible inner and outer crust layers (11, 12) but affords a softer inner layer (13) when cooked in the associated cooking apparatus at the proper temperature for the appropriate time.

The edible container has a shape of a tube with a closed bottom end (14), an opened top end (15) an annular wall (16) extending from the bottom end (14) to the top end (15).

The bottom end (14), top end (15) and annular wall (16) defining a food-receiving cavity (17). The bottom end (14) of the food-receiving cavity (17) has a large surface area that distributes the moisture content of the food product, unlike a cone-shaped form that concentrates the moisture of the food content at its apex.

In the preferred embodiment, the edible container is sized to be hand-held having a length between the top and bottom of between 4½ and 7 inches. In the preferred embodiment, the edible container has a wall thickness of ⅛ to ⅜ inch between inner and outer crust layers (11, 12) and a total outside diameter of between 1 and 2½ inches.

The edible container's tube-shaped cavity (17) is filled with a variety of food products that are held within the non-permeable, leak-proof annular inner crust layer (11) within the length and width of the cavity (17). Therefore, the inner & outer crusts (11, 12), the large surface area bottom and the single top opening for receiving food product, all combine to create an edible container that is leak-proof under normal consumption conditions.

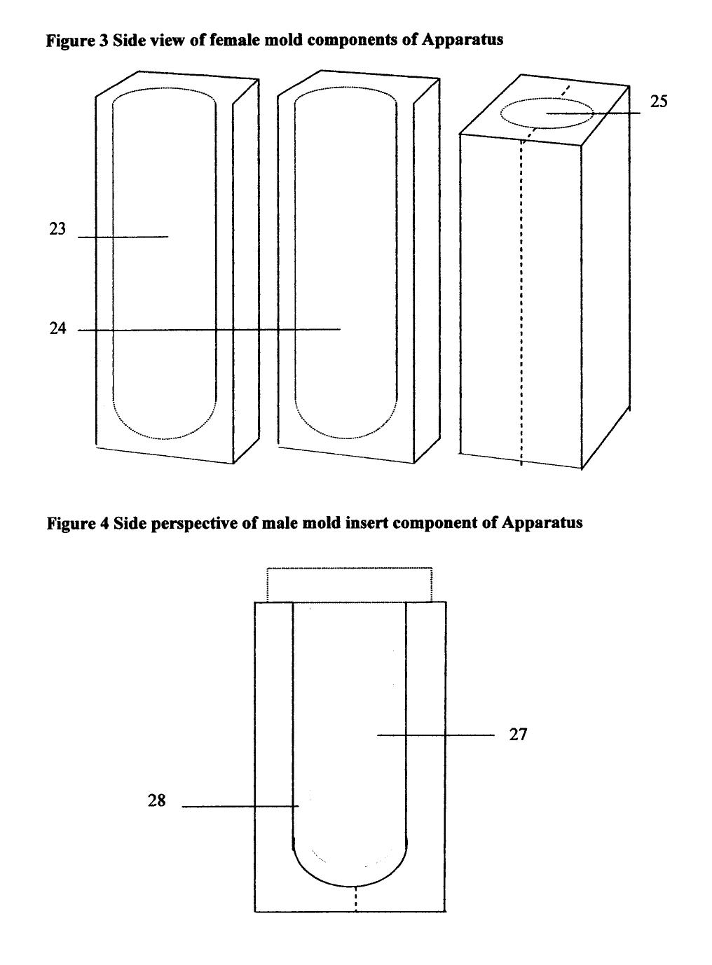

The present invention includes a means and apparatus for making said edible container and receiving a food product. The apparatus is comprised of a pair of complementary female half-molds (FIG. 3), each half-mold having a concave inner surface (23, 24) in a side thereof, so that the hollow portions form a tube-shaped cavity (25) when the half-molds are put together. The apparatus also includes a male mold (FIG. 4) having a tube-shaped outer surface (27).

The outer surface (27) of the male mold being closely spaced from the inner surfaces (23, 24) of the female molds when inserted into the cavity (25); to define an intermediate space (28) that creates the preferred wall thickness of the edible container of between ⅛ to ⅜. The inner surfaces (23, 24) of the female mold and the outer surface of the male mold (27) are coated with a Teflon or non-stick surface.

The method of production comprising the steps include: putting together the pair of complementary female half-molds; inserting a predetermined amount of dough into the tube-shaped cavity (25); the predetermined amount of dough spreading generally evenly therein; inserting the male mold in the tube-shaped cavity (25); initiating the heating process using a heating element source; vibrating the complementary female half-molds at a frequency that enhances product uniformity while minimizing any seam vestige thus limiting damage to the inner and outer crust layers (11, 12) yet allowing heated gases to escape the cavity (25) during cooking; terminating the heating process once the inner and outer layers (11,12) are browned with heat to form a crust; removing the male mold from the edible container, thereby leaving the food-receiving tube-shaped cavity (17).

The invention claimed is:

1. An edible container, the means of and apparatus for production.

2. An edible container according to claim 1, wherein the body is made from an egg-based dough high in protein-based gluten that it creates a non-permeable, leak-proof yet edible inner and out crust and affords a softer inner layer.

3. An edible container according to claims 1 and 2, wherein the body is the shape of the tube with a closed bottom, open top end and annular walls that create a leak proof food cavity that is filled with a variety of food products.

4. An edible container according to claims 1, 2 and 3, wherein the bottom end of the tube distributes the moisture of the contained food product across its surface area thereby further preventing a leak of the contained food.

5. An apparatus according to claim 1, wherein the apparatus is comprised of a set of non-stick coated complementary female half-molds and male mold. Said female half-molds create a hollow tube-shaped cavity when put together.

6. A method of production according to claim 1 and apparatus according in claim 5, wherein the said female half-molds are heated & placed together creating a tube-shaped cavity; inserting a predetermined amount of dough into the cavity;
inserting a heated male mold into the tube-shaped cavity; heating the inserted dough; vibrating the two complementary female half-molds at a frequency that does not destroy the container's crusts yet allows gases to escape the cavity during heating; removing the male mold from the cavity; and, thereby leaving the said non-permeable, leak-proof edible container.
